(19) United States
(12) Patent Application Publication
(10) Pub. No.: US 2013/0156922 A1
(43) Pub. Date: Jun. 20, 2013

(54) Food product comprising a base ingredient comprising cereal seeds

(71) Applicants: Francesco Vessio, Crespadoro (Vicenza) (IT); Pia Tonin, Crespadoro (Vicenza) (IT); Andrea Buffolo, Crespadoro (Vicenza) (IT)

(72) Inventors: Francesco Vessio, Crespadoro (Vicenza) (IT); Pia Tonin, Crespadoro (Vicenza) (IT); Andrea Buffolo, Crespadoro (Vicenza) (IT)

(73) Assignee: Mister Bio Food S.R.L., Crespadoro (IT)

(21) Appl. No.: 13/813,930

(22) PCT Filed: Aug. 5, 2011
(86) PCT No.: PCT/IB11/01822

§ 371 Date: Feb. 28, 2013

(30) Foreign Application Priority Data
Aug. 5, 2010 (IT) VR2010A000164

(51) Int. Cl. A23L 1/10

(52) U.S. Cl. CPC A23L 1/10
USPC 426/535; 426/618; 426/598; 426/578; 426/627; 426/575; 426/576; 426/650; 426/538; 426/536; 426/534; 426/601

(57) ABSTRACT

A vegetable-based food product, without saccharose, lactose and egg, includes a base ingredient having gluten-free cereal seeds, polished and/or wholegrain, and/or sprouted seeds and/or sprouted wholegrain seeds, thickeners and flavorings, which give such a food product a food substitute character, to provide, for example, a substitute for cheese and/or meat and/or fish and/or milk and/or for sweet preparations suitable to be used as such or in industrial or home-made preparations and/or a vegetable drink.

### TECHNICAL FIELD OF THE INVENTION

The present invention concerns a food product comprising a base ingredient comprising cereal seeds.

### STATE OF THE ART

In the food industry, continuous development and research is carried out in order to obtain food products of better quality and organoleptic characteristics, in order to improve the health and well-being of the users of such products.

Moreover, with the increasingly widespread occurrence of allergies and food intolerances, a need has arisen to identify products of natural origin, often biological, which do not contain irritant and allergenic substances. In this way, these products can be used safely by a wide range of users, even those suffering from the aforementioned intolerances and allergies.

The food products object of the present invention are completely organic and usually do not contain substances that can be poorly tolerated by users suffering from certain intolerances and/or pathologies and/or specific dietary requirements, such as: saccharose, lactose and egg.

### PURPOSES OF THE INVENTION

A purpose of the present invention is to provide a food product that comprises cereal seeds.

A further purpose of the present invention is to obtain a vegetable-based food product.

According to an aspect of the present invention, these purposes are achieved by a food product as specified in independent claim 1.

The dependent claims refer to preferred and advantageous embodiments of the invention.

### EMBODIMENTS OF THE INVENTION

The object of present invention is a food product that comprises a base ingredient consisting of seeds derived from cereal. Preferably, the plants from which such seeds are obtained are cultivated biologically or in any case limiting the use of pesticides and fertilizers.

Such a base ingredient is in the form of a fluid or of an anhydrous powder.

The most important cereals from which such seeds are obtained are: corn and/or wheat and/or rice and/or barley and/or sorghum and/or millet and/or oat and/or rye and/or buckwheat, etc.

In a further embodiment, the base ingredient consists of seeds derived from gluten-free cereals. In this case, the gluten-free cereals are selected from the group consisting of: rice, corn, millet, buckwheat, sorghum, amaranth, quinoa.

Cereals provide most of its nutritional energy as starch and they are also important sources of protein, as well as vitamins, amino acids and mineral salts.

The seeds derived from the aforementioned cereals can consist of polished and/or whole grains. The latter are so called wholegrain seeds, which keep the bran and the germ, and in this way are richer in fibre, fatty acids and other precious substances for the body.

The seeds derived from cereals can, in a further embodiment, be semi-wholegrain, in other words seeds in which just a most outer part of the kernel is eliminated.

In a preferred but not exclusive embodiment, such wholegrain seeds can be used as such or possibly be sprouted before use, so as to improve the availability of the nutritional elements of the seeds themselves. The food product according to the invention can possibly contain mixtures of seeds, both sprouted and non-sprouted.

According to a version of the invention, the seeds used are derived from rice.

In an embodiment, the base ingredient comprises sprouted wholegrain rice seeds.

In a further embodiment, the base ingredient can comprise, in addition to the aforementioned seeds derived from cereals, also seeds derived from legumes.

The most important legumes for obtaining the aforementioned food product are: beans and/or broad beans and/or peas and/or lupins and/or chickpeas and/or peanuts and/or soybean and/or lentils, etc.

In an alternative embodiment, in order to obtain the aforementioned food product soybean is not used, due to the allergy and/or intolerance problems that it can cause in some users. In this case, the base ingredient comprises legume seeds selected from the group consisting of beans and/or broad beans and/or peas and/or lupins and/or chickpeas and/or lentils and/or chickling and/or peanuts and/or fabecee and/or trees like acacia (Acacia) and/or pagoda tree (Sophora) and/or false acacia (Robinia pseudoacacia) and/or carub tree (Ceratonia siliqua).

In general, legume seeds contain proteins and also supply a large amount of energy, consisting mostly of carbohydrates. Moreover, they are a source of folic acid, vitamin B1, vitamin H, various minerals including iron, zinc and magnesium, fibres, etc.

In a further embodiment, the base ingredient comprises seeds obtained in general from edible and/or officinal herbs, like, for example, taraxacum, garlic, aloe, laurel, camomile, etc.

The food product according to the present invention comprises water and/or pure water and/or purified water and/or mineral water and/or spring water.

The use of seeds to make the base ingredient, in particular, in the presence of sprouted seeds, determines a particular sensitivity to the attack of pathogens, such as bacteria, fungi or microorganisms in general.

The processing according to the present invention, as better described hereafter, makes it possible to overcome this drawback, managing to keep microbiological contamination under control and allowing a microbiologically stable food product to be obtained.

The base ingredient according to the present invention preferably comprises wholegrain seeds.

Such seeds, moreover, in a non-limiting embodiment of the invention, are micronized in order to obtain micronized particles. Such micronized seeds have, also for the fibrous components, a size of the particles of less than about 30 microns. Preferably, such a size is less than 27 microns, if the micronization step occurs under a pressure of between 50 and 1500 bar. Such a micronization process can also take place completely in water to avoid the possible oxidation of the seeds that, normally, occurs with conventional grinding.

The base product, according to a variant of the present invention or in a non-limiting embodiment of the invention, comprises a high-pressure step, the optimal range of which is between 3000 and 15000 bar, to avoid the use of heat treatments (for example pasteurization or UHT treatments) which can alter the organoleptic properties of the base ingredient itself.

The food product according to the present invention also comprises thickeners and flavourings that can modify its consistency, flavour and/or composition.

The thickeners can be of natural and/or artificial origin and determine an increase in the density and consistency of the base ingredient.

Such thickeners comprise, for example, carrageenan and/or agar-agar and/or starches and/or carob seeds and/or guar and/or xanthan and/or, in general, substances commonly used for such a purpose.

The flavourings included in the food product according to the invention can be of various kind, usually able to be used in the food industry, of the natural and/or artificial type.

Such aromatic molecules comprise: benzaldehyde or benzoic aldehyde, for example to give an almond and black cherry flavour and/or anethole, for example to give an aniseed flavour and/or g-nonalactone, for example to give a coconut flavour and/or eugenol, for example to give a cinnamon flavour and/or menthol, for example to give a balsam flavour and/or diacetyl and butyric acid, for example to give a butter flavour and/or L-carvone, for example to give a peppermint flavour and/or vanillin and/or ethylvanillin, for example to give a vanilla flavour and/or bismethylthiomethane, for example to give a truffle flavour and/or phenylmethylbutyrate, for example to give an apple flavour and/or ethyl butanoate, for example to give a vinegar flavour and/or ethyl acetate, for example to give a kiwi flavour and/or amylacetateisovalerianateisomyl and/or Ylang Ylang, for example to give a banana flavour and/or fencone, for example to give a fennel flavour and/or apiol, for example to give a parsley flavour and/or furylmethanethiol and/or alphafurfurylmercaptan, for example to give a coffee flavour and/or β-damascenonetetramethlpyrazine, for example to give a tea flavour and/or phenylacetic acid and/or fenilethyl acetate, for example to give a honey flavour and/or g-undecalactone, for example to give a peach flavour and/or allyl caproate, for example to give a pineapple flavour and/or frambinone and/or raspberry ketone, for example to give a raspberry flavour and/or ethyl cinnamate, for example to give a cherry flavour and/or methylethylbutanoate, for example to give a red fruit flavour and/or methylthiopropanol, for example to give a boiled potato flavour and/or diallyl disulphide, for example to give a garlic flavour and/or allylpropyl disulphide, for example to give an onion flavour and/or methoxymethylpyrazine, for example to give a pepper flavour and/or heptanoloctanol alcohol, for example to give a mushroom flavour and/or valerenic acid and/or isobutyric acid, for example to give a cheese flavour and/or heptanonemethylthiobutyrate, for example to give a gorgonzola flavour and/or trimethylamine, for example to give a fish flavour and/or methylpyridylketone, for example to give a popcorn flavour and/or ethylhydroxybutanoate, for example to give a meringue flavour and/or pyroligneous acid, for example to give a smoked flavour and/or furaneol, for example to give a strawberry flavour and/or methoxymethylpyrazine, for example to give a toasted hazelnut flavour and/or other flavourings usually used for such a purpose, etc.

The aforementioned flavourings also comprise the aromatic molecules usually used to flavour processed meats and/or the flavourings of aromatic plants, both of the natural and synthetic type, and/or beechwood smoke, and/or spices and/or flavourings for spices, etc.

The food product according to the present invention can optionally comprise lipid or fatty acids, which are emulsified to give particular characteristics of creaminess and consistency to the product itself. Such lipids comprise coconut oil and/or olive oil and/or seed oil and/or vegetable oil in general and/or vegetable margarine, etc.

The food product according to the present invention does not contain animal components or fats and is completely vegetable. Moreover, it does not contain cholesterol, preservatives, lactose, or chemical dyes. In a particular version, the food product according to the invention comprises just substances allowed for biological agriculture, as indicated in European Regulation No.834/2007 and in European Regulation No.889/08.

In an embodiment, the base ingredient, when present in fluid form, comprises a protein and/or fibrous portion and a sugary liquid component and it can be treated in order to separate the protein and/or fibrous portion thereof from the sugary liquid component. The sugary liquid component contains simple sugars, such as maltose, glucose, etc. and is free from saccharose.

Using the protein and/or fibrous portion, the base ingredient, and/or the consequent food product, is enriched in proteins and/or noble substances contained in the fibrous part thereof. The base ingredient thus obtained, having had the starches and sugars present in the liquid component taken away, is more dietetic and has a lower calorie content than the base ingredient before separation. The protein and/or fibrous portion obtained from the base ingredient is suitable for being used as such and/or for enriching the food product object of the present invention with proteins and/or noble substances. Such a protein and/or fibrous portion is also suitable for being used for other purposes, for example as a component of cosmetic or medical compositions and/or as a component of food supplements.

Using the sugary liquid component, which can be as such or variously concentrated, the base ingredient, and/or the consequent food product, is sweetened. The addition of such a sugary liquid substance, free from saccharose or other added sugars, makes it possible to obtain a base ingredient and/or a food product without the need to declare the presence of sweeteners in them.

The sugary liquid, protein and/or fibrous component, obtained from the base ingredient is suitable for being used as such and/or as a sweetener for the food product object of the present invention. Such a sugary liquid component is also suitable for being used for other purposes, for example as a component of cosmetic or medical compositions and/or as a component of food supplements.

In a further embodiment, especially in the case of semi-wholegrain, wholegrain or sprouted wholegrain seeds, the food product according to the invention can be treated through enzyme processes, such as glucotransaminase-based treatments for compacting the proteins and/or alpha-beta-amylase treatments that hydrolyse the starches, and/or, in general, treatments with other enzymes and/or through acid-lactic fermentation. Such enzyme and/or fermentation processes are suitable for facilitating the bioavailability of the seeds themselves.

However, such enzymes are not limited to the examples indicated above and can be variously used as such and/or in mixtures to obtain the desired food product.

In an embodiment of the invention, the enzyme treatments used determine a hydrolysation of the starches in sugars whereas fermentation processes do not take place.

The food product according to the invention can be at least partially dried through atomisation treatments, roller drum, microwaves, heat treatments, desiccators, dehydrators, etc.

Following such drying and/or following concentration, the percentage of water present in the aforementioned food product can be between 1% and 95% for processing requirements of the product itself.

The food product comprising percentages of water between 50% and 95% is in liquid form, for example to obtain milk substitutes and/or drinks and/substitutes for foods in liquid form.

Such milk substitutes and/or drinks can also be enriched with proteins or sweeteners, thanks to the use of the protein and/or fibrous portion or of the sugary liquid component of the base ingredient.

The food product according to the invention, based on seeds obtained from cereals and variously added to and/or dried, can undergo pasteurization or UHT sterilization treatments or other known technologies to improve their conservation characteristics. The food product according to the invention is then packaged to be suitable for subsequent commercialisation.

In a non-limiting embodiment of the invention, the food product according to the present invention undergoes high-pressure treatments, with optimal pressure values within a range between 3000 and 15000 bar, suitable for lowering the microbe content thereof.

In this way the food product according to the present invention is prevented from undergoing heavy alterations in nutritional content and in the organoleptic characteristics thereof.

The food product according to the invention is in the form of a food substitute, in other words a food replacement, which is vegetable-based and in particular cereal seed-based, suitable for replacing, in the food industry, products of animal origin. Such a substitute can be a substitute for cheese, meat, fish or preparations for the confectionary industry, according to whether it replaces and has the characteristics—such as taste, aroma and consistency—of cheese, meat, fish or of preparations for the confectionary industry of conventional origin.

Such a substitute can also be a milk substitute and/or a vegetable drink.

Such substitutes can be used as such or in industrial or home-made preparations, like, as a non-limiting example, savoury preparations such as cheeses, meats, fish, etc. or sweet preparations, such as pudding, yoghurt, sour cream, cream spreads and preparations usually made using milk of animal origin, and/or milk substitute itself.

Therefore, the food product according to the invention, based on the various percentages, compositions and mixtures of the thickeners, of the flavourings and, possibly, of the lipids that it contains, can have a particular or desired taste, composition and aroma.

The food product according to the present invention, therefore, replaces “original” foodstuffs, such as cheese, meat, fish, sweets, milk, drinks, etc. However, since it is of vegetable instead of animal origin, such a food product can also be used by people suffering from allergies, intolerances, particular pathologies, or who follow certain diets such as vegetarians, vegans and, in general, anybody who prefers to use foodstuffs of vegetable origin rather that foodstuffs of another origin.

Moreover, the food product according to the present invention can be used as an ingredient for various food preparations, both sweet and savoury.

The present invention thus conceived can undergo numerous modifications and variants, all of which are covered by the scope of protection of the claims.

The invention claimed is:

1. Vegetable-based food product, free from saccharose, lactose and egg, comprising:
a base ingredient comprising cereal seeds, selected from one or more of polished or wholegrain seeds, said base ingredient being in form of a fluid or an anhydrous powder, wherein said cereal seeds are gluten-free cereal seeds; and
thickeners and flavorings, which give said food product a food substitute character suitable for use as such or in industrial or home-made preparations, or as a milk substitute or a vegetable drink.

2. The food product according to claim 1, wherein said wholegrain seeds are sprouted seeds.

3. The food product according to claim 1, wherein said cereal seeds are rice seeds.

4. The food product according to claim 1, wherein said gluten-free cereal seeds are selected from the group consisting of:
rice, corn, millet, buckwheat, sorghum, amaranth, and quinoa.

5. The food product according to claim 1, wherein said thickeners comprise one or more of carrageenan, agar-agar, starches, carob seeds, guar, xanthan, or other substance commonly used as a thickener.

6. The food product according to claim 1, wherein said flavorings comprise flavorings usually used in the food industry, natural or artificial type, benzaldehyde, benzoic aldehyde, anethole, g-nonalactone, eugenol, menthol, diacetyl and butyric acid, L carvone, vanillin, ethylvanillin, bismethylthiomethane, phenylmethylbutyrate, ethyl butanoate, ethyl acetate, amylacetateisovalerianateisomyl, Ylang Ylang, fencone, apiol, furylmethanethiol, alpha-furfurylmercaptan, β-damascenonetetramethylpyrazine, phenylacetic acid, phenylethyl acetate, g-undecalactone, allyl caproate, frambinone, raspberry ketone, ethyl cinnamate, methylethylbutanoate, methylthiopropanol, diallyl disulphide, allylpropyl disulphide, methoxymethylpyrazine, heptanoloctanol alcohol, valerenic acid, isobutyric acid, heptanonemethylthiobutyrate, trimethylamine, methylpyridylketone, ethylhydroxybutanoate, pyroligneous acid, furaneol, methoxymethylpyrazine, other flavorings usually used for as a flavoring, aromatic molecules usually used to flavor processed meats, the flavourings of aromatic plants, both of natural and synthetic kind, beechwood smoke, spices, or flavorings for spices.

7. The food product according to claim 1, wherein said food product comprises lipids.

8. The food product according to claim 1, wherein said food product comprises seeds rich in bioavailable nutritional substances obtained through enzyme processes.

9. The food product according to claim 1, wherein said food product comprises a percentage of water between 1% and 95%.

10. The food product according to claim 1, wherein said food product is in solid form.

11. The food product according to claim 1, wherein said food product is in liquid form.

12. The food product according to claim 1, further comprising water.

13. The food product according to claim 1, wherein said base ingredient is in fluid form and comprises a protein or fibrous portion and a sugary liquid component and wherein said protein or fibrous portion is suitable for being separated from said liquid component.

14. The food product according to claim 13, wherein said protein or fibrous portion is suitable for being used as such or for enriching said food product with proteins or noble substances, or is suitable for being used as a component of cosmetic or medical compositions or as a component of food supplements.

15. The food product according to claim 13, wherein said sugary liquid component is suitable for being used as such or in concentrated form or to sweeten said food product, or is suitable for being used as a component of cosmetic or medical compositions or as a component of food supplements.

16. The food product according to claim 1, wherein said food product is pasteurized, sterilized by UHT, made suitable for storage, or treated at a pressure within a range between 3000 and 15000 bar.

17. The food product according to claim 1, wherein said base ingredient comprises legume seeds.

18. The food product according claim 1, wherein said base ingredient comprises legume seeds selected from the group consisting of beans, broad beans, peas, lupins, chickpeas, peanuts, lentils, chuckling, fabaceae, acacia (Acacia), pagoda tree (Sophora), false acacia (Robinia pseudoacacia), or carub tree (Ceratonia siliqua).

19. The food product according to claim 1, wherein said base ingredient comprising seeds obtained from edible or officinal herbs.

20. The food product according to claim 19, wherein said seeds are whole.

21. The food according to claim 19, wherein said seeds are micronized in order to obtain micronized particles.

22. The food product according to claim 22, wherein said micronized particles have a size of less than 30 microns if subjected to a pressure between 50 and 1500 bar.

23. The food product according to claim 1, wherein said food product is a vegetable substitute for cheese, meat, fish, or sweet preparations.
